(19) United States
(12) Patent Application Publication
(10) Pub. No.: US 2012/0189354 A1
(43) Pub. Date: Jul. 26, 2012

(54) DEVELOPING DEVICE AND IMAGE FORMING APPARATUS

(75) Inventors: Hokuto HATANO, Toyokawa-shi (JP); Takayuki Takai, Anjo-shi (JP); Takuya Okada, Toyokawa-shi (JP); Takuya Sasaki, Toyokawa-shi (JP)

(73) Assignee: Konica Minolta Business Technologies, Inc., Chiyoda-ku (JP)

(21) Appl. No.: 13/354,933

(22) Filed: Jan. 20, 2012

(30) Foreign Application Priority Data
Jan. 21, 2011 (JP) 2011-011093

(51) Int. Cl. G03G 15/08

(52) U.S. Cl. 399/258

(57) ABSTRACT

A developing device has a first toner carrier which carries, on an outer peripheral surface, toner to be fed to an electrostatic latent image formed on an image carrier and which is arranged out of contact with the image carrier; a second toner carrier which carries, on an outer peripheral surface, toner to be fed to the electrostatic latent image and which is arranged out of contact with the image carrier; and a developer carrier which carries a developer made up of toner and carriers and which feeds the toner to the first toner carrier and the second toner carrier. The toner carried by each of the first toner carrier and the second toner carrier is caused to adhere to the electrostatic latent image formed on the image carrier by application of an AC bias voltage to each of the first toner carrier and the second toner carrier.

This application is based on Japanese Patent Application No. 2011-011093 filed on Jan. 21, 2011, the content of which is incorporated herein by reference.

### BACKGROUND OF THE INVENTION

1. Field of the Invention

The present invention relates to a developing device, especially a developing device for developing an electrostatic latent image formed on a photoreceptor in electrophotographic image formation, and an image forming apparatus.

2. Description of Related Art

Recently, in the field of electrophotographic image formation, as a development system for developing an electrostatic latent image formed on a photoreceptor (image carrier), attention has been focused on a hybrid development system that has both the advantage of a one-component development system that uses a developer containing only toner and the advantage of a two-component development system that uses a developer containing toner and carriers stirred/mixed together. In this hybrid development system, after toner and carriers are stirred/mixed to charge the toner, the toner is separated from the carriers by the action of a separation electric field formed between a developer carrying roller that carries a developer (the mixture of toner and carriers) and a development roller (toner carrying roller) for feeding the toner to the photoreceptor, and only the toner is held on the development roller. In this way, one-component development is performed on an electrostatic latent image on the photoreceptor.

In the hybrid development, a plurality of development rollers are arranged in the rotating direction of the photoreceptor to seek expansion of a development area, so as to be ready for high-speed development (see Japanese Patent Laid-Open Publication Nos. 2005-37523 and 2006-276853).

In such a hybrid developing device having a plurality of development rollers, generally, an alternate current (AC) electrical field is formed in a development area between the photoreceptor and each of the development rollers, and the toner is reciprocated between the development roller and the photoreceptor to perform development. Although toner needs to be reciprocated a sufficient number of times for performing development with fine density evenness (evenness of the amount of development toner), the time for development has been shortened with speeding up the development, and there has thus been a problem of deterioration in reproducibility of a thin line, a microdot and the like, resulting in development unevenness. In order to solve such a problem, lengthening a diameter of the development roller or further increasing the number of development rollers may be considered. However, these measures are not desirable because these measures will result in an increase in size and an increase in cost of the developing device.

### SUMMARY OF THE INVENTION

A developing device according to an embodiment of the present invention comprises: a first toner carrier which carries, on an outer peripheral surface, toner to be fed to an electrostatic latent image formed on an image carrier and which is arranged out of contact with the image carrier; a second toner carrier which carries, on an outer peripheral surface, toner to be fed to the electrostatic latent image and which is arranged out of contact with the image carrier and downstream from the first toner carrier in a rotating direction of the image carrier; and a developer carrier which carries a developer made up of toner and carriers and which feeds the toner to the first toner carrier and the second toner carrier, wherein: the toner carried by each of the first toner carrier and the second toner carrier is caused to adhere to the electrostatic latent image formed on the image carrier by application of an AC bias voltage to each of the first toner carrier and the second toner carrier; and an amount Ahigh of development toner fed from the first toner carrier to a solid portion of the electrostatic latent image on the image carrier and an amount Bhigh of development toner fed from the second toner carrier to the solid portion of the electrostatic latent image on the image carrier satisfy a condition Ahigh Bhigh, and an amount Alow of development toner fed from the first toner carrier to a background portion of the electrostatic latent image on the image carrier and an amount Blow of development toner fed from the second toner carrier to the background portion of the electrostatic latent image on the image carrier satisfy a condition Alow>Blow.

### BRIEF DESCRIPTION OF THE DRAWINGS

The features of the present invention will be apparent from the following description with reference to the accompanying drawings, in which:

FIG. 1 is a sectional view showing an image forming apparatus comprising a developing device according to an embodiment of the present invention, a photosensitive drum and peripheral equipment thereof;

FIGS. 2A and 2B are charts showing a bias voltage that is applied to a development roller, where FIG. 2A shows the relation between an AC bias voltage and the potential of a latent image on a photoreceptor to perform development achieving a large amount of development toner, and FIG. 2B shows the relation between the AC bias voltage and the latent image potential on the photoreceptor to perform development achieving a small amount of development toner; and

FIGS. 3A to 3D are explanatory views showing adhesion of toner onto the photoreceptor.

### DETAILED DESCRIPTION OF THE PREFERRED EMBODIMENTS

Hereinafter, a developing device and an image forming apparatus according to an embodiment of the present invention will be described with reference to the attached drawings.

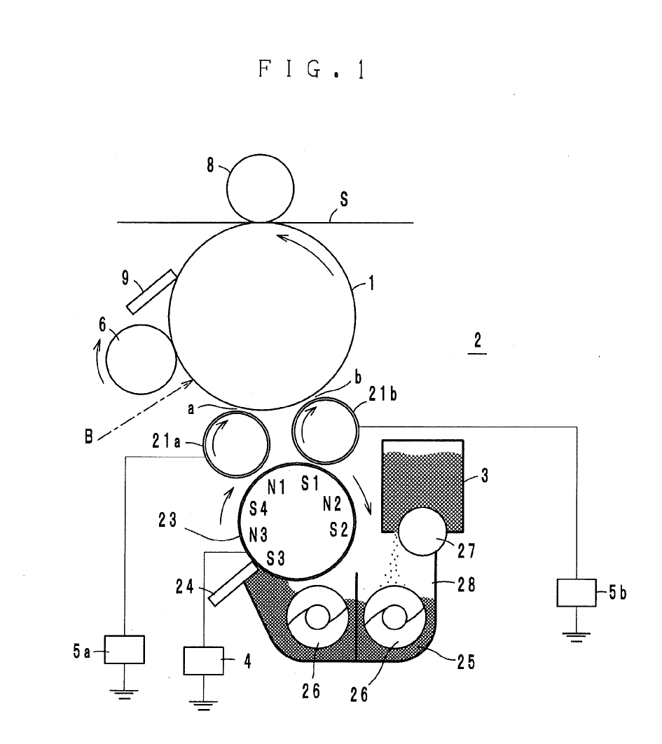

FIG. 1 shows an electrophotographic image forming apparatus using a developing unit according to an embodiment of the present invention. As shown in FIG. 1, a developing device 2 serves to develop an electrostatic latent image formed on a photoreceptor (image carrier) 1 into a visible image with toner. While the photoreceptor 1 is rotating counterclockwise indicated by an arrow in FIG. 1, the photoreceptor 1 is electrically charged in a uniform manner to a predetermined potential by an electrical charging roller 6, an electrostatic latent image is formed thereon with a laser beam B emitted from a laser scanning device (not shown), the electrostatic latent image is developed into a toner image by the developing device 2, the toner image is transferred to record paper S by the effect of an electric field formed by a transfer roller 8, and remaining toner is removed by a blade 9. Further, a remaining electric charge is removed by an eraser (not shown). It is to be noted that a process of forming an image by electrophotography by use of this kind of image forming unit is known, and a detailed description thereof is thus omitted.

In addition, as the electric charger or the transfer device, a corotron discharger or a scorotron discharger may be used in place of the roller 6 and the roller 8, and as the exposure device, a type of device using light other than laser may be used.

The developing device 2 is provided with a toner supply bottle 3, a developer bath 28 for containing a developer 25 composed of toner and carriers, a developer carrying roller 23 that carries the developer 25 on its outer peripheral surface and conveys the developer 25 in its rotating direction (clockwise direction), and first and second development (toner carrying) rollers 21a and 21b, each of which separates toner from the outer peripheral surface of the developer carrying roller 23 to carry the toner on its own outer peripheral surface and conveys it in its rotating direction (clockwise direction), to perform hybrid development. Further, the developer carrying roller 23 is connected with a high-voltage power supply circuit 4, and the first and second development rollers 21a and 21b are connected with high-voltage power supply circuits 5a and 5b.

The toner is supplied in units of a predetermined amount from the toner supply bottle 3 to the developer bath 28 with rotation of a toner supply roller 27. Two stirring conveyance rollers 26 are arranged on the bottom of the developer bath 28. The supplied toner is stirred/mixed with the carriers with rotation of the rollers 26, to be electrically charged to a predetermined potential, and conveyed to a lower portion of the first developer carrying roller 23. The stirring/mixing action of the developer 25 by means of the stirring conveyance rollers 26 is similar to that of the conventional developing device, and a detailed description thereof is thus omitted.

The developer carrying roller 23 is configured of a sleeve that is driven to rotate in an arrow direction (clockwise direction), and a magnetic roller built/fixed into the sleeve. The magnetic roller has magnetic poles N1, S1, N2, S2, S3, N3 and S4 along the rotating direction of the sleeve. The rotating direction of the sleeve is the same as the rotating directions of the first and second development rollers 21a and 21b, and the sleeve moves in the opposite direction to the rollers 21a and 21b at opposed parts.

The developer 25 conveyed to the vicinity of the developer carrying roller 23 by the stirring conveyance rollers 26 is carried on the outer peripheral surface of the sleeve by magnetic force of the magnetic pole S3 of the magnetic roller, controlled in layer thickness (passage amount) by a control blade 24, and sent to the opposed parts to the first and second development rollers 21a, 21b. The first development roller 21a is arranged upstream in a rotating direction (counterclockwise direction) of the photoreceptor 1, and then driven to rotate in a clockwise direction as indicated by an arrow. The second development roller 21b is arranged downstream in the rotating direction of the photoreceptor 1, and then driven to rotate in the clockwise direction as indicated by an arrow.

The principal magnetic poles N1 and S1 of the magnetic roller are respectively opposed to the first and second development rollers 21a and 21b, and separate the toner from the developer 25 to supply the toner to the development rollers 21a and 21b. The magnetic poles S2 and S3 are arranged immediately above the developer bath 28, and generate repelling magnetic fields for peeling the developer 25 carried on the sleeve therefrom.

In opposed areas of the developer carrying roller 23 to the first and second development rollers 21a and 21b, electric fields are formed by the high-voltage power supply circuit 4 such that the toner is electrically separated from the developer 25 and moved to the outer peripheral surfaces of the rollers 21a and 21b. Further, in development areas a and b where the first and second development rollers 21a and 21b are opposed to the photoreceptor 1, electric fields are formed by the high-voltage power supply circuits 5a and 5b such that the toner is moved to the outer peripheral surface of the photoreceptor 1.

Thereat, the toner fed from the developer carrying roller 23 and carried in a layer on the outer peripheral surface of the first development roller 21a is conveyed to the development area a opposed to the photoreceptor 1 with rotation of the first development roller 21a. As the toner is reciprocated between the photoreceptor 1 and the development roller 21a by an electric field which is formed between a voltage of an electrostatic latent image formed on the photoreceptor 1 and an AC bias voltage applied from the high-voltage power supply circuit 5a to the development roller 21a, the electrostatic latent image is developed. Further, the toner carried from the developer carrying roller 23 to the outer peripheral surface of the second development roller 21b is conveyed to the development area b opposed to the photoreceptor 1 with rotation of the second development roller 21b. As the toner is reciprocated between the photoreceptor 1 and the development roller 21b by an electric field formed between a voltage of the electrostatic latent image formed on the photoreceptor 1 and an AC bias voltage applied from the high-voltage power supply circuit 5b to the development roller 21b, the electrostatic latent image is developed.

The development rollers 21a and 21b are each configured of a conductive roller made of a metal material, such as an aluminum-made roller with its surface subjected to alumite treatment. Each of the development rollers 21a and 21b may be one obtained by applying coating on a roller body with polyester resin, polycarbonate resin, polyethylene resin, polyamide resin, polyimide resin, polysulfone resin, silicone resin, fluorine resin or the like, or with silicone rubber, urethane rubber or the like.

For the developer as the mixture of toner and carriers, toner of a generally used type can be employed. Specifically, toner obtained by adding a coloring agent, a charging control agent, a mold release agent or the like as necessary to a binder resin and further adding an external additive. The toner particles desirably have diameters on the order of 3 to 10 μm. As the carriers, generally used binder-type carriers, coat-type carriers or the like can be employed. The particles of the carriers desirably have diameters on the order of 15 to 100 μm. A mixing ratio between the toner and the carriers may be adjusted so as to achieve a desired toner charge amount. Practically, the mixing ratio is set such that a coverage factor of the toner to the surface of each carrier is on the order of 20 to 40%.

Now, a bias voltage applied to the development rollers 21a and 21b is described. AC electric fields are formed between the development roller 21a and the developer carrying roller 23 and between the development roller 21b and the developer carrying roller 23 by the high-voltage power supply circuits 4, 5a and 5b, and thereby, the toner is supplied from the developer carrying roller 23 to the development rollers 21a and 21b. In each of the development areas a and b, the development rollers 21a and 21b and the photoreceptor 1 are configured to be out of contact with each other in order that the toner flies in a space between the development roller 21a and the photoreceptor 1 and in a space between the development roller 21b and the photoreceptor 1 due to the electric fields to faithfully develop the electrostatic latent image on the photoreceptor 1. In this structure, the AC electric fields are formed.

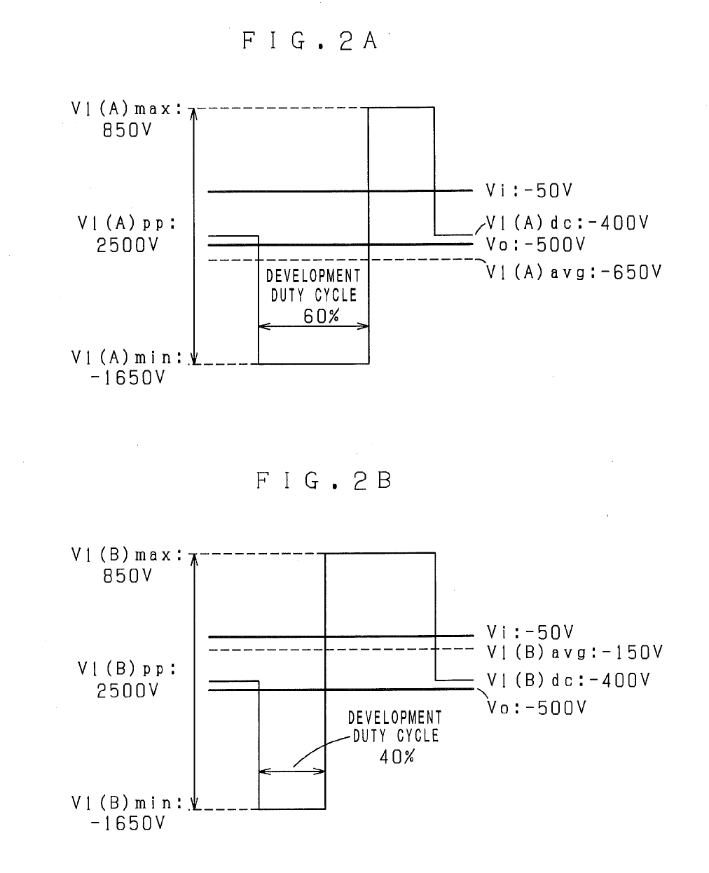

FIGS. 2A and 2B each show the relation between an AC bias voltage applied to each of the development rollers 21a and 21b, and the potential of a solid latent image on the photoreceptor 1. FIG. 2A shows a case of achieving a large amount of development toner, and FIG. 2B is a case of achieving a small amount of development toner. The photoreceptor 1 and the toner are negatively charged.

The developing device 2 is set as follows. At the time of developing a solid portion of a latent image, a condition Ahigh Bhigh is satisfied, wherein Ahigh is the amount of toner adhering to the solid portion of the latent image subjected to only development in the upstream development area a, that is, the amount of toner supplied to the solid portion of the latent image by the upstream development roller 21a, and Bhigh is the amount of toner adhering to the solid portion of the latent image subjected to only development in the downstream development area b, that is, the amount of toner supplied to the solid portion of the latent image by the downstream development roller 21b. At the time of developing a background portion of a latent image, a condition Alow>Blow is satisfied, wherein Alow is the amount of toner adhering to the background portion of the latent image subjected to only development in the development area a, that is, the amount of toner supplied to the background portion of the latent image by the upstream development roller 21a, and Blow is the amount of toner adhering to the background portion of the latent image subjected to only development in the downstream development area b, that is, the amount of toner supplied to the background portion of the latent image by the downstream development roller 21b.

The amount of toner supplied by the development roller and adhering to a latent image is adjustable, for example, by changing a duty cycle of the AC bias voltage. FIGS. 2A and 2B show an example thereof. FIG. 2A shows the case of setting the development duty cycle of the AC bias voltage to 60%, and FIG. 2B shows the case of setting the development duty cycle to 40%. The toner moves to the photoreceptor 1 in a period of applying a minimal value of the AC bias voltage, and separates from the photoreceptor 1 in a period of applying a maximal value thereof, and hence the amount of development toner (toner adhering to the photoreceptor) increases as the duty cycle increases.

In the meantime, with changes in development duty cycle, an average value of the development voltage changes as shown by V1(A)avg and V1(B)avg in FIGS. 2A and 2B. The difference between this average value of the development voltage and the potential Vi of an electrostatic latent image on the photoreceptor 1 corresponds to the amount of toner actually used for development. As the average value of the development voltage becomes further in the minus side from the potential Vi of a latent image, the amount of toner adhering to the photoreceptor (the amount of development toner) increases. On the contrary, as the average value of the development voltage becomes further in the plus side from the potential Vi of a latent image, the amount of toner separating from the latent image and collected by the development roller increases.

In the present embodiment, at the time of developing a background portion of a latent image, the developing device 2 is set so as to achieve excessive amount of development toner in the upstream development area a and to perform toner collection in the downstream development area b. In the upstream development area a, the development bias voltage is −400 V, a peak-to-peak value (the difference between the maximum value and the minimum value) of the AC development voltage is 2500 V, and the development duty cycle is set to 60%. In this case, the average value V1(A)avg of the development voltage is −650 V. As the average value of the development voltage becomes further in the minus side from the potential Vi of the latent image, the amount of development toner increases. In the downstream development area b, the development bias voltage is −400 V, and the peak-to-peak value is 2500 V, which are the same in the upstream development area a. However, the development duty cycle is set to 40%, and the average value V1(B)avg of the development voltage is −150 V. Thus, the average value V1(B)avg is higher than, that is, in the plus side from the potential Vo of −500 of the background portion of the latent image. In the downstream development area b, therefore, toner is collected from the photoreceptor. As described above, the voltages are in the relation V1(A)avg<Vo<V1(B)avg.

Hence in the present embodiment, without applying different AC bias voltages having different peak-to-peak values to the first and second development rollers 21a and 21b, that is, with equalizing the center values V(A)dc and V1(B)dc of the voltages applied to the first and second development rollers 21a and 21b to each other, the average voltage values V1(A)avg and V1(B)avg are set different from each other. Thereby, leakage of electric charge to the image portion can be prevented.

The amount of development toner supplied by the development roller 21a (the amount of toner supplied by the development roller 21a and adhering to a latent image) and the amount of development toner supplied by the development roller 21b (the amount of toner supplied by the development roller 21b and adhering to the latent image) can be made different from each other not only by making the average values Vavg of the development voltages applied to the development rollers 21a and 21b from each other but also by making the surface potentials of the development rollers 21a and 21b different from each other. For example, different materials are used for the surface layers of the first and second development rollers 21a and 21b such that the surface layer of the upstream development roller 21a will have a lower dielectric constant to have a higher potential and such that the surface layer of the downstream development roller 21a will have a higher dielectric constant to have a lower potential. Also, the amount of development toner supplied by the development roller 21a and the amount of development toner supplied by the development roller 21b can be made different from each other by making the toner conveyance amounts of the first and second development rollers 21a and 21b different from each other. The toner amount conveyed by the upstream development roller 21a may be set larger, and the toner amount conveyed by the downstream development roller 21b may be set smaller. In this case, the toner conveyance amounts can be adjusted by changing the ratio of the rotational peripheral speed of each of the development rollers 21a and 21b to the rotational peripheral speed of the photoreceptor 1. Herein, the toner conveyance amount is a value obtained by multiplying a toner amount (toner carriage amount [g/m²]) on the surface of each of the development rollers 21a and 21b by a rotational peripheral speed ratio θ of each of the development rollers 21a and 21b (the ratio of the rotational peripheral speed of each of the development rollers 21a and 21b to the rotational peripheral speed of the photoreceptor 1). Herein, θ=1 means that the ratio of the rotational peripheral speed of the photoreceptor 1 to the rotational peripheral speed the toner carrier (the development roller 21a or 21b) is 1:1, and θ=2 means that the ratio of the rotational peripheral speed of the photoreceptor 1 to the rotational peripheral speed the toner carrier is 1:2. It is set such that the total of the toner conveyance amount of the first development roller 21a and the toner conveyance amount of the second development roller 21b is larger than a toner amount required for development of the solid portion of a latent image, that is, a toner amount required to adhere to the solid portion after development by the second development roller 21b, that is, immediately after the solid portion passes through the development area b.

The toner conveyance amount of the first development roller 21a is preferably from 3 to 10 g/m². By setting the toner conveyance amount of the first development roller 21a to be equal to or greater than 3 g/m², the thin-line reproducibility and the density stability of a halftone portion improve more. Further, by setting the toner conveyance amount equal to or less than than 10 g/m², the white-line reproducibility and the gradation reproducibility improve more. It is to be noted that the toner carriage amount of the first development roller 21a is preferably larger than the toner carriage amount of the second development roller 21b. Moreover, from the viewpoint of preventing an increase in load on a driving mechanism of the first development roller 21a caused by increasing the rotational peripheral speed ratio θ of the first development roller 21a, the toner carriage amount of the first development roller 21a is preferably equal to or greater than 2 g/m². Furthermore, from the viewpoint of suppressing the loss of development stability due to an effect exerted on the electric field in the development area b by charges of toner not used for development and remaining in the second development roller 21b, the toner carriage amount of the second development roller 21b is preferably is equal to or less than 6 g/m².

In the present embodiment, the developing device 2 is set such that at the time of developing a solid portion (high-density portion) of a latent image, the amount of development toner supplied by the second development roller 21b is equal to or larger than the amount of development toner supplied by the first development roller 21a. Therefore, even if the development at the upstream development area a is insufficient, toner additionally adheres to the solid portion in the downstream development area b, and the black-line reproducibility is improved, thereby preventing density unevenness in the high density portion. On the other hand, at the time of developing a background portion (low-density portion) of a latent image, the amount of development toner supplied by the second development roller 21b is smaller than the amount of development toner supplied by the first development roller 21a. Therefore, even if toner excessively adheres to the background portion in the upstream development area a, the excess toner is collected in the downstream development area b. Consequently, the thin-line reproducibility and microdot reproducibility improve, while the density unevenness and toner fogging are suppressed, and the gradation reproducibility also improves.

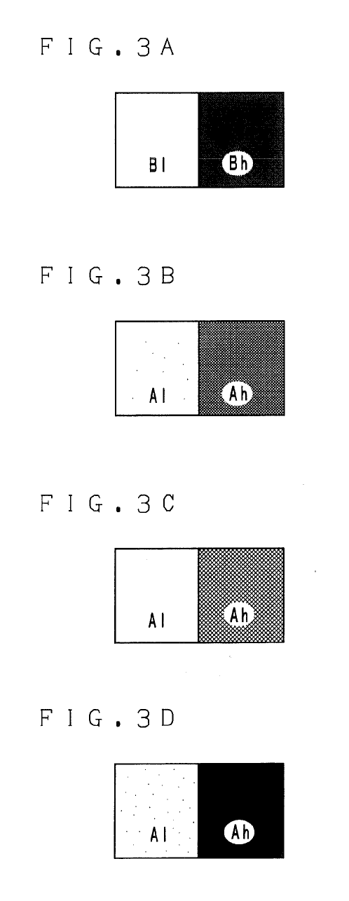

As shown in FIG. 3A, in the present embodiment, toner fogging does not occur in a background portion Bl of a latent image after the portion Bl passes through the development areas a and b, and the toner adheres to a solid portion Bh of the latent image at high density after the portion Bh passes through the development areas a and b. FIG. 3B shows the background portion and the solid portion immediately after these portions pass through the upstream development area a. As shown in the left side of FIG. 3B, toner fogging slightly occurs in the background portion Al immediately after the portion Al passes through the upstream development area a. However, the fogged toner is collected while the portion Al is passing through the downstream development area b. Also, even if the solid portion Ah is not developed at sufficiently high density in the upstream development area a as shown in the right side of FIG. 3B, toner additionally adheres to the solid portion Ah while the solid portion Ah is passing through the downstream development area b, resulting in formation of a high-density image.

FIG. 3C shows a case wherein the amounts of development toner respectively supplied by the first development roller 21a and the second development roller 21b are set such that conditions Ahigh Bhigh and Alow=Blow are satisfied. In this case, immediately after a latent image passes through the upstream development area a, toner fogging does not occur in the background portion Al, but the density of the solid portion Ah of the latent image is quite low. FIG. 3D shows a case wherein the amounts of development toner respectively supplied by the first development roller 21a and the second development roller 21b are set such that conditions Ahigh>Bhigh and Alow>Blow are satisfied. In this case, immediately after a latent image passes through the upstream development area a, toner fogging occurs in the background portion Al in a considerable degree compared with the case shown in FIG. 3B, and the density of the solid portion Ah of the latent image is higher than necessary.

### Experimental Examples

By using 20 examples (Inventive Examples 1-20) of the development device 2 and comparative examples (Comparative Examples 1 to 7), the following experiments were conducted. In the examples, the system speed (paper conveyance speed) was 800 mm/sec. The conditions for the development bias in each of the examples (Inventive Examples and Comparative Examples) were those shown in Table 1 below.

The following were fixed conditions for all the examples. The photoreceptor 1 had a diameter of 100 mm, and each of the development rollers 21a and 21b had a diameter of 25 mm. Gaps Ds between the development roller 21a and the photoreceptor 1 and between the development roller 21b and the photoreceptor 1 were 250 μm at the respective closest points. A square-wave AC bias voltage with a frequency of 5 kHz was applied to each of the development rollers 21a and 21b as shown in FIGS. 2A and 2B. A bias voltage applied to the developer carrying roller 23 was adjusted such that the developer carriage amount per unit area on the developer carrying roller 23 was 6 g/m². A background portion of an electrostatic latent image formed on the photoreceptor 1 had a potential of −400 V, and a solid image portion thereof had a potential of −50V. Further, the number of rotations of each of the development rollers 21a and 21b was set such that the ratio of the rotational peripheral speed of each of the rollers to the rotational peripheral speed of the photoreceptor 1 was 1:1.

Values for other various items were set shown in Table 1 below. The AC development voltages applied to the upstream and downstream development rollers 21a and 21b have the same peak-to-peak value “Vpp”. DC bias voltages applied to the upstream development roller 21a and the downstream development roller 21b are denoted as Vdc1 and Vdc2 respectively, and the development duty cycles thereof are denoted as duty1 and duty2 respectively. The average potentials thereof are denoted as Vavg1 and Vavg2 respectively. Relation 1 shown in Table 2 represents the relation of the amount of development toner in developing a solid portion, and specifically, represents the relation between the amount of development toner Ah by the upstream development roller 21a and the amount Bh of development toner supplied by the downstream development roller 21b. Relation 2 shown in Table 2 represents the relation of the amount of development toner in developing a background portion, and specifically represents the relation between the amount of development toner Al supplied by the upstream development roller 21a and the amount of development toner B1 supplied by the downstream development roller 21b.

Further, values of Ah and Bh were calculated by converting densities of printed images into the amounts of toner adhering to the portion of the latent image on the photosensitive drum. In calculating the value Ah, the density of an image printed with a bias voltage applied only to the upstream development roller 21a was measured. With regard to values of Al and Bl, since the amount of toner adhering to the portion is minute, the rate of toner adhering to a white solid image was calculated by examining a microscope image. In addition, the amount of development toner Bh in the solid portion subjected to development in the downstream development area b was set to 5 g/m², from which a required image density results.

Printing was performed under the variety of conditions shown in Table 1 (Inventive Examples 1 to 20 and Comparative Examples 1 to 7), and the printed images were evaluated in terms of black-line reproducibility (one-dot vertical thin line and one-dot diagonal thin line at 1200 dpi), density unevenness (half-tone portion of 2×2), toner fogging (rate of area where toner adheres) in the background portion, white-line reproducibility (3-point white letter at 1200 dpi) and gradation reproducibility (16-level gradation).

In any of the evaluation items, an extremely favorable level is indicated as ⊙, a practically favorable level as ∘ and an unfavorable level as x (apparently defective) in Table 3. Inventive Examples 1 to 20 were given favorable evaluations shown by ⊙ or ∘ in all the evaluation items. On the other hand, any of Comparative Examples 1 to 7 was given x in a plurality of evaluation items, and evaluated particularly as being on an unfavorable level of gradation reproducibility.

TABLE 1

| | Vpp | Vdc1 | Vdc2 | duty | duty | Vavg1 | Vavg2 |
|---|---|---|---|---|---|---|---|
| | (V) | (V) | (V) | 1 | 2 | (V) | (V) |
| Inventive | 2500 | −400 | −300 | 50 | 50 | −400 | −300 |
| Example 1 | | | | | | | |
| Inventive | 2500 | −350 | −300 | 50 | 50 | −350 | −300 |
| Example 2 | | | | | | | |
| Inventive | 2500 | −325 | −300 | 50 | 50 | −325 | −300 |
| Example 3 | | | | | | | |
| Inventive | 2500 | −450 | −300 | 50 | 50 | −450 | −300 |
| Example 4 | | | | | | | |
| Inventive | 2250 | −400 | −300 | 50 | 50 | −400 | −300 |
| Example 5 | | | | | | | |
| Inventive | 2250 | −350 | −300 | 50 | 50 | −350 | −300 |
| Example 6 | | | | | | | |
| Inventive | 2250 | −325 | −300 | 50 | 50 | −325 | −300 |
| Example 7 | | | | | | | |
| Inventive | 2250 | −450 | −300 | 50 | 50 | −450 | −300 |
| Example 8 | | | | | | | |
| Inventive | 2000 | −400 | −300 | 50 | 50 | −400 | −300 |
| Example 9 | | | | | | | |
| Inventive | 2000 | −350 | −300 | 50 | 50 | −350 | −300 |
| Example 10 | | | | | | | |
| Inventive | 2000 | −325 | −300 | 50 | 50 | −325 | −300 |
| Example 11 | | | | | | | |
| Inventive | 2000 | −450 | −300 | 50 | 50 | −450 | −300 |
| Example 12 | | | | | | | |
| Inventive | 2500 | −200 | −300 | 60 | 50 | −450 | −300 |
| Example 13 | | | | | | | |
| Inventive | 2500 | −300 | −300 | 55 | 50 | −425 | −300 |
| Example 14 | | | | | | | |
| Inventive | 2500 | −425 | −425 | 50 | 45 | −425 | −300 |
| Example 15 | | | | | | | |
| Inventive | 2500 | −175 | −175 | 60 | 55 | −425 | −300 |
| Example 16 | | | | | | | |
| Inventive | 2000 | −200 | −300 | 62 | 50 | −440 | −300 |
| Example 17 | | | | | | | |
| Inventive | 2000 | −300 | −300 | 57 | 50 | −440 | −300 |
| Example 18 | | | | | | | |
| Inventive | 2000 | −425 | −425 | 50 | 44 | −425 | −305 |
| Example 19 | | | | | | | |
| Inventive | 2000 | −175 | −175 | 62 | 56 | −415 | −295 |
| Example 20 | | | | | | | |
| Comparative | 2500 | −300 | −300 | 50 | 50 | −300 | −300 |
| Example 1 | | | | | | | |
| Comparative | 2500 | −250 | −300 | 50 | 50 | −250 | −300 |
| Example 2 | | | | | | | |
| Comparative | 2500 | −300 | −400 | 50 | 50 | −300 | −400 |
| Example 3 | | | | | | | |
| Comparative | 2500 | −500 | −300 | 50 | 50 | −500 | −300 |
| Example 4 | | | | | | | |
| Comparative | 2500 | −300 | −300 | 45 | 50 | −175 | −300 |
| Example 5 | | | | | | | |
| Comparative | 2500 | −300 | −300 | 45 | 55 | −175 | −425 |
| Example 6 | | | | | | | |
| Comparative | 2500 | −300 | −300 | 60 | 50 | −550 | −300 |
| Example 7 | | | | | | | |

TABLE 2

| | | Back- | | | | |
|---|---|---|---|---|---|---|
| | Solid | ground | | | | |
| | portion | portion | | | | |
| | Rela- | Rela- | Ah | Bh | Al | Bl |
| | tion 1 | tion 2 | (g/m²) | (g/m²) | (g/m²) | (g/m²) |
| Inventive | Aₕ ≦ Bₕ | A₁ > B₁ | 4.5 | 5 | 1 | 0 |
| Example 1 | | | | | | |
| Inventive | Aₕ ≦ Bₕ | A₁ > B₁ | 4 | 5 | 0.5 | 0 |
| Example 2 | | | | | | |
| Inventive | Aₕ ≦ Bₕ | A₁ > B₁ | 3.5 | 5 | 0.25 | 0 |
| Example 3 | | | | | | |
| Inventive | Aₕ ≦ Bₕ | A₁ > B₁ | 5 | 5 | 1.5 | 0 |
| Example 4 | | | | | | |
| Inventive | Aₕ ≦ Bₕ | A₁ > B₁ | 4.5 | 5 | 1 | 0 |
| Example 5 | | | | | | |
| Inventive | Aₕ ≦ Bₕ | A₁ > B₁ | 4 | 5 | 0.5 | 0 |
| Example 6 | | | | | | |
| Inventive | Aₕ ≦ Bₕ | A₁ > B₁ | 3.5 | 5 | 0.25 | 0 |
| Example 7 | | | | | | |
| Inventive | Aₕ ≦ Bₕ | A₁ > B₁ | 5 | 5 | 1.5 | 0 |
| Example 8 | | | | | | |
| Inventive | Aₕ ≦ Bₕ | A₁ > B₁ | 4.5 | 5 | 1 | 0 |
| Example 9 | | | | | | |
| Inventive | Aₕ ≦ Bₕ | A₁ > B₁ | 4 | 5 | 0.5 | 0 |
| Example 10 | | | | | | |
| Inventive | Aₕ ≦ Bₕ | A₁ > B₁ | 3.5 | 5 | 0.25 | 0 |
| Example 11 | | | | | | |
| Inventive | Aₕ ≦ Bₕ | A₁ > B₁ | 5 | 5 | 1.5 | 0 |
| Example 12 | | | | | | |
| Inventive | Aₕ ≦ Bₕ | A₁ > B₁ | 4.5 | 5 | 1 | 0 |
| Example 13 | | | | | | |
| Inventive | Aₕ ≦ Bₕ | A₁ > B₁ | 4 | 5 | 0.5 | 0 |
| Example 14 | | | | | | |
| Inventive | Aₕ ≦ Bₕ | A₁ > B₁ | 3.5 | 5 | 0.25 | 0 |
| Example 15 | | | | | | |
| Inventive | Aₕ ≦ Bₕ | A₁ > B₁ | 5 | 5 | 1.5 | 0 |
| Example 16 | | | | | | |
| Inventive | Aₕ ≦ Bₕ | A₁ > B₁ | 4.5 | 5 | 1 | 0 |
| Example 17 | | | | | | |
| Inventive | Aₕ ≦ Bₕ | A₁ > B₁ | 4 | 5 | 0.5 | 0 |
| Example 18 | | | | | | |
| Inventive | Aₕ ≦ Bₕ | A₁ > B₁ | 3.5 | 5 | 0.25 | 0 |
| Example 19 | | | | | | |
| Inventive | Aₕ ≦ Bₕ | A₁ > B₁ | 5 | 5 | 1.5 | 0 |
| Example 20 | | | | | | |
| Comparative | Aₕ ≦ Bₕ | A₁ = B₁ | 5 | 5 | 0 | 0 |
| Example 1 | | | | | | |
| Comparative | Aₕ ≦ Bₕ | A₁ = B₁ | 4 | 5 | 0 | 0 |
| Example 2 | | | | | | |
| Comparative | Aₕ ≦ Bₕ | A₁ < B₁ | 5 | 5 | 0 | 0.5 |
| Example 3 | | | | | | |
| Comparative | Aₕ > Bₕ | A₁ > B₁ | 5.5 | 5 | 2 | 1 |
| Example 4 | | | | | | |
| Comparative | Aₕ ≦ Bₕ | A₁ = B₁ | 4 | 5 | 0 | 0 |
| Example 5 | | | | | | |
| Comparative | Aₕ ≦ Bₕ | A₁ < B₁ | 2 | 5 | 0 | 0.5 |
| Example 6 | | | | | | |
| Comparative | Aₕ > Bₕ | A₁ > B₁ | 5.5 | 5 | 2 | 1 |
| Example 7 | | | | | | |

TABLE 3

| | Evaluation item | | | | |
|---|---|---|---|---|---|
| | | | Fogging in | | |
| | Black-line | Density | background | White-line | Gradation |
| | reproducibility | unevenness | portion | reproducibility | reproducibility |
| Inventive Example 1 | ⊙ | ⊙ | ⊙ | ⊙ | ⊙ |
| Inventive Example 2 | ⊙ | ⊙ | ⊙ | ◯ | ⊙ |
| Inventive Example 3 | ⊙ | ⊙ | ⊙ | ◯ | ⊙ |
| Inventive Example 4 | ⊙ | ⊙ | ◯ | ◯ | ◯ |
| Inventive Example 5 | ⊙ | ⊙ | ⊙ | ⊙ | ⊙ |
| Inventive Example 6 | ⊙ | ◯ | ⊙ | ⊙ | ⊙ |
| Inventive Example 7 | ⊙ | ◯ | ⊙ | ⊙ | ⊙ |
| Inventive Example 8 | ⊙ | ⊙ | ◯ | ◯ | ◯ |
| Inventive Example 9 | ◯ | ⊙ | ⊙ | ⊙ | ⊙ |
| Inventive Example 10 | ◯ | ◯ | ⊙ | ⊙ | ⊙ |
| Inventive Example 11 | ◯ | ◯ | ⊙ | ⊙ | ⊙ |
| Inventive Example 12 | ◯ | ⊙ | ◯ | ◯ | ◯ |
| Inventive Example 13 | ⊙ | ◯ | ⊙ | ⊙ | ⊙ |
| Inventive Example 14 | ⊙ | ⊙ | ⊙ | ⊙ | ⊙ |
| Inventive Example 15 | ⊙ | ⊙ | ◯ | ⊙ | ⊙ |
| Inventive Example 16 | ⊙ | ◯ | ⊙ | ⊙ | ⊙ |
| Inventive Example 17 | ◯ | ⊙ | ⊙ | ⊙ | ⊙ |
| Inventive Example 18 | ◯ | ◯ | ⊙ | ⊙ | ⊙ |
| Inventive Example 19 | ◯ | ◯ | ◯ | ⊙ | ⊙ |
| Inventive Example 20 | ◯ | ◯ | ⊙ | ⊙ | ⊙ |
| Comparative Example 1 | X | X | ⊙ | ◯ | X |
| Comparative Example 2 | X | X | ⊙ | ◯ | X |
| Comparative Example 3 | ◯ | ◯ | X | X | X |
| Comparative Example 4 | ⊙ | ⊙ | ◯ | X | X |
| Comparative Example 5 | X | X | ⊙ | ◯ | X |
| Comparative Example 6 | ◯ | ◯ | X | X | X |
| Comparative Example 7 | ⊙ | ⊙ | ◯ | X | X |

### Other Embodiments

The developer carrying roller may be arranged for each development roller. The rotating directions of the photoreceptor, the developer carrying roller and the development rollers are not restricted to the directions described in the above embodiment. The variety of rollers can be made of various materials. Also, for the toner and the carriers, various materials can be used. The development system may be of a conventionally known type, either a regular development type or a reversal development type.

Although the present invention has been described in connection with the preferred embodiment above, it is to be noted that various changes and modifications are possible to those who are skilled in the art. Such changes and modifications are to be understood as being within the scope of the present invention.

What is claimed is:

1. A developing device comprising:
a first toner carrier which carries, on an outer peripheral surface, toner to be fed to an electrostatic latent image formed on an image carrier and which is arranged out of contact with the image carrier;
a second toner carrier which carries, on an outer peripheral surface, toner to be fed to the electrostatic latent image and which is arranged out of contact with the image carrier and downstream from the first toner carrier in a rotating direction of the image carrier; and
a developer carrier which carries a developer made up of toner and carriers and which feeds the toner to the first toner carrier and the second toner carrier, wherein:
the toner carried by each of the first toner carrier and the second toner carrier is caused to adhere to the electrostatic latent image formed on the image carrier by application of an AC bias voltage to each of the first toner carrier and the second toner carrier; and
an amount Ahigh of development toner fed from the first toner carrier to a solid portion of the electrostatic latent image on the image carrier and an amount Bhigh of development toner fed from the second toner carrier to the solid portion of the electrostatic latent image on the image carrier satisfy a condition Ahigh≦Bhigh, and an amount Alow of development toner fed from the first toner carrier to a background portion of the electrostatic latent image on the image carrier and an amount Blow of development toner fed from the second toner carrier to the background portion of the electrostatic latent image on the image carrier satisfy a condition Alow>Blow.

2. The developing device according to claim 1, wherein:
the toner is negatively charged; and
an average value Vavg1 of the AC bias voltage applied to the first toner carrier, an average value Vavg2 of the AC bias voltage applied to the second toner carrier and a potential Vo of the background portion of the electrostatic latent image satisfy a condition Vavg1<Vo<Vavg2.

3. The developing device according to claim 1, wherein
a toner conveyance amount of the first toner carrier is from 3 to 10 g/m².

4. The developing device according to claim 1, wherein:
a total of a toner conveyance amount of the first toner carrier and a toner conveyance amount of the second toner carrier is larger than an amount of toner which is required to adhere to the solid portion of the electrostatic latent image after the solid portion passes through an area where the second toner carrier and the image carrier are opposed to each other.

5. The developing device according to claim 1, wherein:
a toner carriage amount of the first toner carrier is larger than a toner carriage amount of the second toner carrier; and
the toner carriage amount of the first toner carrier is equal to or greater than 2 g/m².

6. The developing device according to claim 1, wherein:
a toner carriage amount of the first toner carrier is larger than a toner carriage amount of the second toner carrier; and
the toner carriage amount of the second toner carrier is equal to or smaller than 6 g/m².

7. An image forming apparatus comprising the developing device according to claim 1.

8. The image forming apparatus according to claim 7, wherein:
the toner is negatively charged; and
an average value Vavg1 of the AC bias voltage applied to the first toner carrier, an average value Vavg2 of the AC bias voltage applied to the second toner carrier and a potential Vo of the background portion of the electrostatic latent image satisfy a condition Vavg1<Vo<Vavg2.

9. The image forming apparatus according to claim 7, wherein a toner conveyance amount of the first toner carrier is from 3 to 10 g/m².

10. The image forming apparatus according to claim 7, wherein
a total of a toner conveyance amount of the first toner carrier and a toner conveyance amount of the second toner carrier is larger than an amount of toner which is required to adhere to the solid portion of the electrostatic latent image after the solid portion passes through an area where the second toner carrier and the image carrier are opposed to each other.

11. The image forming apparatus according to claim 7, wherein:
a toner carriage amount of the first toner carrier is larger than a toner carriage amount of the second toner carrier; and
the toner carriage amount of the first toner carrier is equal to or greater than 2 g/m².

12. The image forming apparatus according to claim 7, wherein:
a toner carriage amount of the first toner carrier is larger than a toner carriage amount of the second toner carrier; and
the toner carriage amount of the second toner carrier is equal to or smaller than 6 g/m².
